(19) United States
(12) Patent Application Publication
(10) Pub. No.: US 2023/0145132 A1
(43) Pub. Date: May 11, 2023

(54) Power Tool Attachment Device

(71) Applicant: Rick Cryer, Wichita Falls, TX (US)

(72) Inventor: Rick Cryer, Wichita Falls, TX (US)

(21) Appl. No.: 17/519,904

(22) Filed: Nov. 5, 2021

(51) Int. Cl. B25F 5/02; F16B 33/02

(52) U.S. Cl. CPC B25F 5/02; F16B 33/02

(57) ABSTRACT

A power tool attachment device for securing an accessory to a power tool is disclosed. The power tool attachment device includes a first threaded portion and a second threaded portion. The second threaded portion has a shape and size different from the first threaded portion. The first threaded portion inserts in a hole of a power tool while the second threaded portion remains outside of the hole. The second threaded portion is shaped and sized to be able to attach accessories of the power tool. The second threaded portion receives and secures an accessory to the power tool, via an accessory hole that conforms to the shape and size of the second threaded portion. The power tool attachment device allows to attach the accessory such as a nut to the power tool such as a grinder, for example so that the accessory does not get lost.

### CROSS-REFERENCE TO RELATED APPLICATIONS

None.

### FIELD OF THE DISCLOSURE

The present invention relates to a power tool attachment device, and more specifically, to a power tool attachment device such as a screw insert capable of securing accessories to a power tool when not in use.

### BACKGROUND OF THE INVENTION

Power tools, such as grinders, have several potential attachments. For example, the grinder includes grinder wheels that come in a variety of shapes and sizes. In order to attach and secure a grinder wheel to the grinder, a nut is screwed over the wheel so that when the wheel spins, the wheel remains attached to the grinder. A user may have several different types of nuts to hold a grinder wheel in place, and different grinder nuts may be used for different types of grinder wheels. Thus, when a user wants to switch grinder wheels, the user may have to place a grinder nut on a table, the ground, or pocket, and may lose the nut.

Currently, there is no mechanism or means to safely keep the nut without it being lost when the grinder wheels are switched. Thus, there remains a continuing need for improved devices that retain nuts and other accessories in easy to access places without getting lost.

### BRIEF SUMMARY OF THE PRESENT INVENTION

It is an object of the present invention to provide an improved power tool attachment device and that avoids the drawbacks of known art.

It is another object of the present invention to provide a power tool attachment device capable of securing accessories to a power tool when not in use or between switching of the accessories.

It is another object of the present invention to provide a power tool attachment device that helps to attach accessories having varied shapes and sizes to a power tool so that the accessories do not get lost.

In order to achieve one or more objects, the present invention provides a power tool attachment device for securing an accessory to a power tool. The power tool attachment device includes a first threaded portion and a second threaded portion. The second threaded portion has a shape and size different from the first threaded portion. In one example, the first threaded portion has diameter, pitch, and length, larger than the second threaded portion. In another example, the second threaded portion has diameter, pitch, and length, larger than the first threaded portion.

The first threaded portion inserts in a hole of the power tool while the second threaded portion remains outside of the hole. The second threaded portion is shaped and sized to be able to attach accessories of the power tool. The second threaded portion receives and connects an accessory to the power tool, via an accessory hole that conforms to the shape and size of the second threaded portion.

In one advantageous feature of the present invention, the power tool attachment device helps to attach an accessory such as a nut to the power tool such as a grinder, for example so that the accessory does not get lost.

In another advantageous feature of the present invention, when the power tool includes holes, each provided at either side of its housing, the power tool attachment device attaches at one side and allows the hole on another side to be used for connecting a handle. This way, the power tool attachment device helps to hold accessories without affecting the operation of the power tool.

Features and advantages of the subject matter hereof will become more apparent in light of the following detailed description of selected embodiments, as illustrated in the accompanying FIGS. As will be realized, the subject matter disclosed is capable of modifications in various respects, all without departing from the scope of the subject matter. Accordingly, the drawings and the description are to be regarded as illustrative in nature.

### BRIEF DESCRIPTION OF THE DRAWINGS

FIG. 1 illustrates an environment in which a power tool attachment device connects to a power tool, in accordance with one exemplary embodiment of the present invention;

FIGS. 2A and 2B illustrate a front side perspective view and a front view, respectively of the power tool attachment device;

FIG. 3 illustrates a perspective view of a power tool;

FIG. 4 illustrates a side perspective view in which the power tool attachment device inserts into a hole at one side of the power tool, in accordance with one embodiment of the present invention;

FIG. 5 illustrates a top perspective view of an accessory;

FIG. 6 illustrates a side perspective view in which the power tool attachment device secures the accessory to the power tool, in accordance with one embodiment of the present invention; and

FIG. 7 illustrates a side perspective view in which the power tool attachment device secures the accessory to the power tool, in accordance with one exemplary embodiment of the present invention.

### DETAILED DESCRIPTION OF EMBODIMENTS

The invention now will be described more fully hereinafter with reference to the accompanying drawings, in which embodiments of the invention are shown. This invention may however be embodied in many different forms and should not be construed as limited to the embodiments set forth herein. Rather, these embodiments are provided so that this disclosure will be thorough and complete, and will fully convey the scope of the invention to those skilled in the art.

It will be understood that when an element is referred to as being “on” another element, it can be directly on the other element or intervening elements may be present therebetween. As used herein, the term “and/or” includes any and all combinations of one or more of the associated listed items.

It will be understood that, although the terms first, second, third etc. may be used herein to describe various elements, components, regions, layers, and/or sections, these elements, components, regions, layers, and/or sections should not be limited by these terms. These terms are only used to distinguish one element, component, region, layer, and/or section from another element, component, region, layer, and/or section.

It will be understood that the elements, components, regions, layers and sections depicted in the figures are not necessarily drawn to scale.

The terminology used herein is for the purpose of describing particular embodiments only, and is not intended to be limiting of the invention. As used herein, the singular forms “a,” “an,” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom,” “upper” or “top,” “left” or “right,” “above” or “below,” “front” or “rear,” may be used herein to describe one element's relationship to another element as illustrated in the Figures. It will be understood that relative terms are intended to encompass different orientations of the device in addition to the orientation depicted in the Figures.

Unless otherwise defined, all terms used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments of the present invention are described herein with reference to idealized embodiments of the present invention. As such, variations from the shapes of the illustrations as a result, for example, of manufacturing techniques and/or tolerances, are to be expected. The numbers, ratios, percentages, and other values may include those that are ±5%, ±10%, ±25%, ±50%, ±75%, ±100%, ±200%, ±500%, or other ranges that do not detract from the spirit of the invention. The terms about, approximately, or substantially may include values known to those having ordinary skill in the art. If not known in the art, these terms may be considered to be in the range of up to ±5%, ±10%, or other value higher than these ranges commonly accepted by those having ordinary skill in the art for the variable disclosed. Thus, embodiments of the present invention should not be construed as limited to the particular shapes of regions illustrated herein but are to include deviations in shapes that result, for example, from manufacturing. The invention illustratively disclosed herein suitably may be practiced in the absence of any elements that are not specifically disclosed herein.

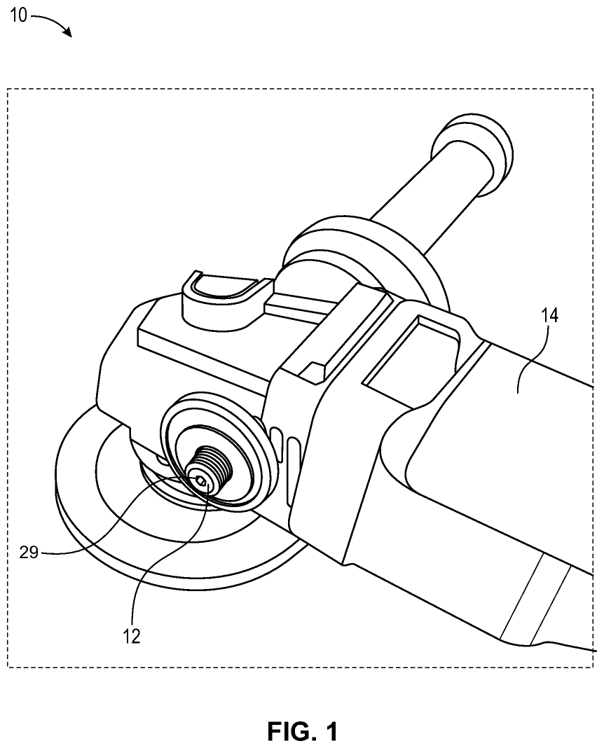

Turning to the Figures, FIG. 1 shows an environment 10 in which power tool attachment device 12 implements, in accordance with one exemplary embodiment of the present invention. Power tool attachment device 12 connects to power tool 14. In the present invention, power tool attachment device 12 indicates and includes a screw insert or step screw-like structure. Power tool 14 includes, but not limited to, a grinder, joiner, drill, saw, screwdriver, hammer, vibrator, sander, polisher, nibbler, cutter, blower, heat gun, etc.

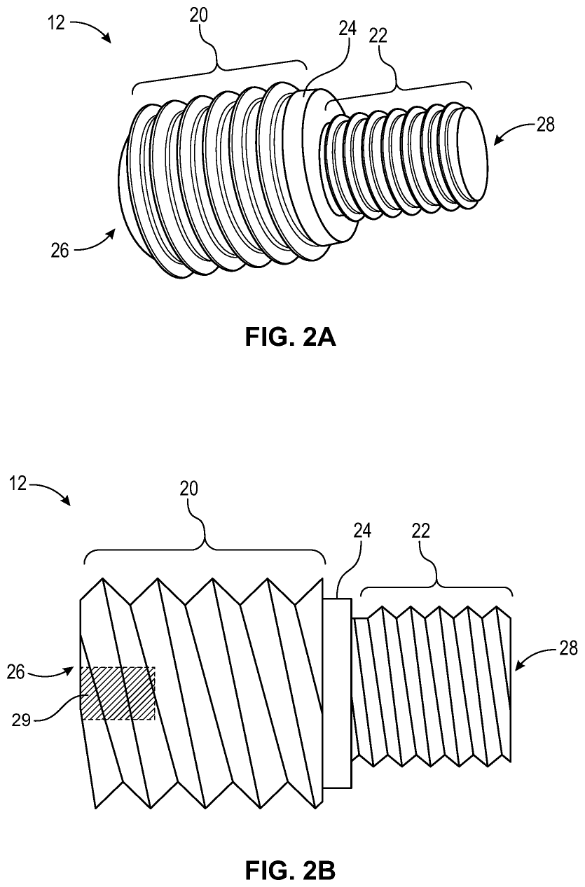

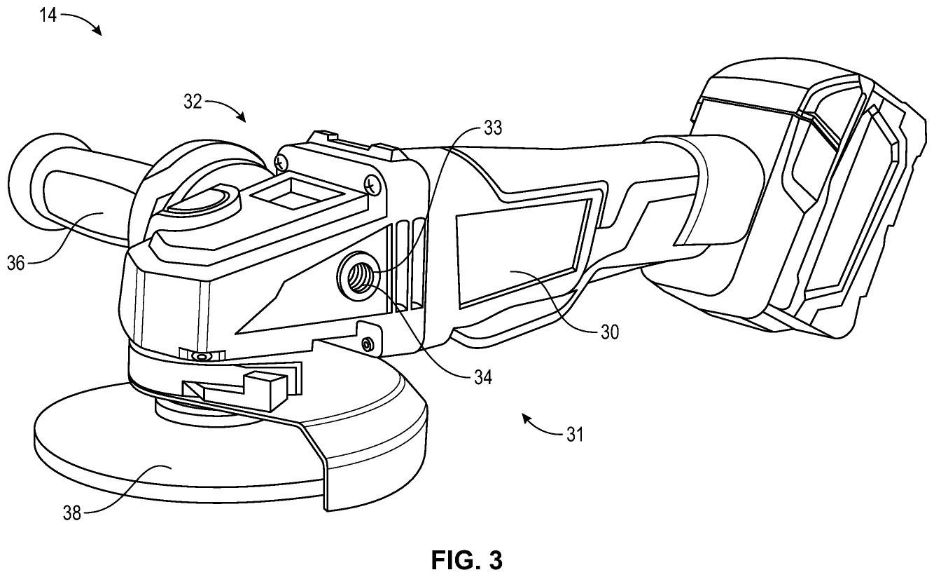

FIGS. 2A and 2B show a front side perspective view and a front view, respectively of power tool attachment device 12, in accordance with one embodiment of the present invention. Power tool attachment device 12 provides a material made of metal, hard plastic, or any other suitable material. Power tool attachment device 12 includes first threaded portion 20 (i.e., first cylindrical body region with threads) and second threaded portion 22 (i.e., second cylindrical body region with threads). First threaded portion 20 and second threaded portion 22 connect via connecting body 24. Connecting body 24 has a smooth surface. Power tool attachment device 12 includes first end 26 and second end 28. First end 26 indicates a first side of power tool attachment device 12 and second end 28 indicates a second side of power tool attachment device 12. Here, first threaded portion 20 extends towards first end 26 and second threaded portion 22 extends towards second end 28 from connecting body 24.

In the present invention, first threaded portion 20 has a larger diameter than second threaded portion 22. As such, threads in first threaded portion 20 have a larger pitch than threads in second threaded portion 22. For example, each thread in first threaded portion 20 has a pitch of about ⅝-11″ (nominal size and threads per inch) and each thread in second threaded portion 22 has a pitch of about 1.0-1.5″. Further, first threaded portion 20 has a diameter of 0.62 inches. Further, second threaded portion 22 has a diameter of 0.40 inches. Furthermore, connecting body 24 has a diameter of about 0.50 inches. As can be seen from at least FIG. 2B, connecting body 24 presents a step-like structure with first threaded portion 20 and second threaded portion 22 presents a step-like structure with connecting body 24 due to the difference in their respective diameters. In the present example, each of first threaded portion 20, connecting body 24 and second threaded portion 22 has a length of about 0.60 inches, 0.075 inches and 0.40 inches, respectively thereby making the total length of power tool attachment device 12 of about 1.075 inches. A person skilled in the art appreciates that the dimensions are provided for illustrative purpose and it is possible to change the dimensions such as length, diameter, pitch of threads of each of first threaded portion 20 and second threaded portion 22 depending on need, e.g., depending on power tool 14 used and/or accessory 40 that needs to be connected. In one implementation, one threaded portion, say first threaded portion 20 is provided in a standard size having a pitch of about ⅝-11″ while second threaded portion 22 is provided with a different size and pitch depending on the power tool 14 and/or accessory 40 that needs to be secured. Alternatively, second threaded portion 22 is provided in a standard size with a pitch of about ⅝-11″ while first threaded portion 20 is provided with a different size and pitch depending on the power tool 14 and/or accessory 40 that needs to be secured. While ⅝-11″ is industry standard for the second threaded portion, the first threaded portion may be dependent upon the brand and size of the grinder. Thus, the dimensions may be varied according to fit with the brand of the grinder or other power tool (both the second threaded portion, and especially the first threaded portion dimensions), without detracting from the spirit of the invention. For example the size of the thread pitch count may be M14-2.0, M12-1.75, M10-1.5, M8-1.25, land 5/16-18.

A person skilled in the art understands that power tool 14, say a grinder has holes at either side. The presently disclosed power tool attachment device 12 is positioned in one or both holes for connecting accessories when they are not in use. FIG. 3 shows a perspective view of power tool 14 as known in the art. In the present description, a grinder is used for explaining the working of power tool attachment device 12. However, the embodiments of the present invention can be implemented using any other power tool such as a joiner, drill, saw, screwdriver, hammer, vibrator, sander, polisher, nibbler, cutter, blower, heat gun, etc., without departing from the scope of the present invention. As known, power tool 14 includes housing or body 30. Housing 30 presents first side 31 and second side 32. First side 31 indicates a left side and second side 32 indicates a left side, or vice versa. Further, housing 30 includes identical holes or screw holes 33 on both first side 31 and second side 32. Each hole 33 includes threaded portion 34. Typical power tool 14 (i.e., angle grinder) utilizes stabilizing handle 36 that a user holds during its use. Handle 36 includes a connecting screw (not shown) that inserts in hole 33 either on first side 31 or on second side 32 of housing 30. FIG. 3 shows handle 36 connected at hole 33 at second side 32 of housing 30, while leaving hole 32 on first side 31 empty or unused. If needed, the user switches handle 36 and connects to hole 33 at first side 32 of housing 30, while leaving hole 33 on second side 31 empty or unused. In both scenarios, one hole remains unused.

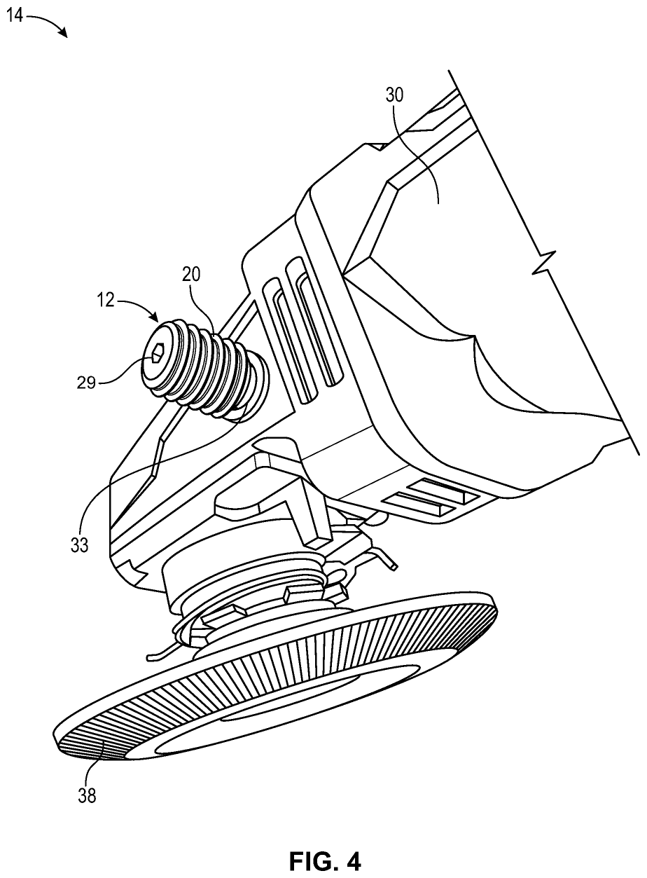

In accordance with the present invention, power tool attachment device 12 inserts in free or unused hole 33 (i.e., hole 33 on first side 31) and helps to connect accessory 40 while hole 33 on second side 32 is used for connecting handle 36 (FIG. 3). FIG. 4 shows a side perspective view of power tool attachment device 12 inserted into hole 33 at first side 31 of housing 30. Here, second threaded portion 22 conforms to shape and size of threaded portion 34 of hole 33. As such, second threaded portion 22 inserts into hole 33 and first threaded portion 20 remains outside of hole 33 due to its larger diameter. Although it is shown that second threaded portion 22 inserts into hole 33 and first threaded portion 20 remains outside of hole 33, it is possible to insert first threaded portion 20 in hole 33 while retaining second threaded portion 22 outside of hole 33. A person skilled in the art understands that such an implementation depends on the size of threaded portion 34 of hole 33 and accessory 40 that needs to be secured with the help of power tool attachment device 12.

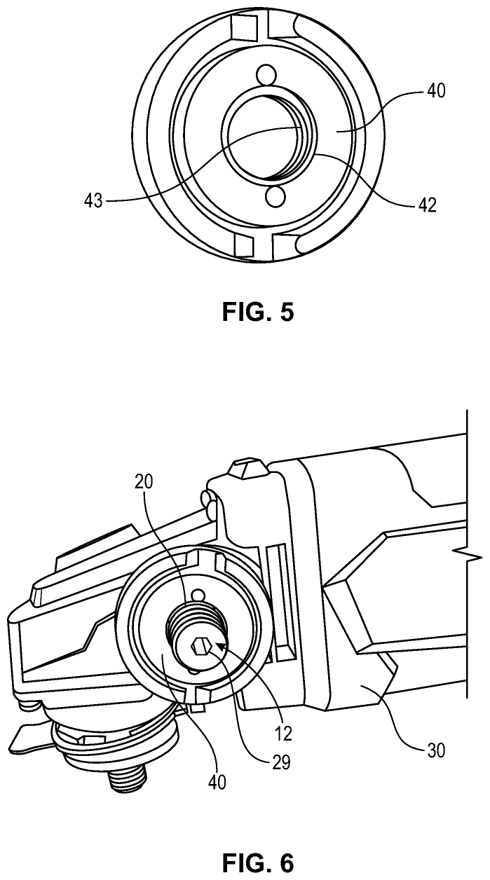

As known, power tool 14 such as a power grinder includes grinding wheel or grinding disc 38 screwed to housing 30 with the help of accessory 40 such as a nut. Accessory 40 e.g., nut is screwed over grinding wheel 38 so that when grinding wheel 38 spins, grinding wheel 38 remains attached to power tool 14. Accessory 40 is removed and placed over a surface such as a table or ground in order to switch grinding wheel 38 to another grinder wheel 38 (or polish or buffing wheel) or when it is not required to secure grinding wheel 38 to housing 30. Accessory 40 includes accessory hole 42 with threaded portion 43. FIG. 5 shows a top perspective view of accessory 40 such as a nut, for example. In one example, threaded portion 43 of accessory hole 42 has a shape and size (pitch of ⅝-11″) that conforms to the shape of first threaded portion 20 (pitch of ⅝-11″) such that accessory 40 secures to power tool attachment device 12 at first threaded portion 20. A person skilled in the art understands that accessory 40 can come in different shapes and sizes depending on the need. For example, accessory 40 includes, but not limited to, a nut, locking member, connecting member, ring, or any other accessory or device used to secure components of power tool 14.

In accordance with the present invention, after accessory 40 is removed, accessory 40 is connected to power tool attachment device 12 which is connected to hole 33. This way, accessory 40 is secured to power tool 14 via power tool attachment device 12 and ensures that it does not get lost during the switching of grinding wheel 38 (or when it is not needed). As specified above, power tool attachment device 12 connects to hole 33 at the free side (first side 31) of housing 30 in that second threaded portion 22 inserts into hole 33 and first threaded portion 20 remains outside of hole 33. In accordance with the present invention, accessory 40 screws onto first threaded portion 20, as shown in FIG. 6. Here, first side 31 of housing 30 includes power tool attachment device 12 securing accessory 40 (FIG. 6) and second side 32 of housing 30 includes handle 36 (FIG. 3). A person skilled in the art understands that each of first threaded portion 20 and second threaded portion 22 is shaped and sized to be able to attach/receive accessory 40 depending on the size of hole 33 and accessory hole 42. For example, first threaded portion 20 is shaped and sized to conform to the shape of the accessory 40 i.e., accessory hole 42 that remains outside of hole 33, while the second threaded portion 22 is shaped and sized to conform to the shape threaded portion 34 of hole 33. Similarly, second threaded portion 22 is shaped and sized to conform to the shape of accessory 40 i.e., accessory hole 42 that remains outside of hole 33, while first threaded portion 20 is shaped and sized to conform to the shape threaded portion 34 of hole 33.

When needed, the user unscrews accessory 40 from power tool attachment device 12 leaving power tool attachment device 12 connected to power tool 14, as shown in FIG. 3, for example.

In another embodiment, power tool attachment device 12 is used to secure grinding wheel 38 along with accessory 40 to housing 30. For example, consider grinding wheel 38 is removed from housing 30 for connecting a buffing wheel (not shown). In such a scenario, at first, grinding wheel 38 containing a hole (not shown) is inserted/screwed at first threaded portion 20 that is outside of hole 33. Subsequently, accessory 40 is connected to first threaded portion 20 to secure grinding wheel 38 at one side i.e., first side 31 of housing 30.

Although the above description is explained considering that power tool attachment device 12 connects at one side of housing 30, it is possible to use holes 33 at both sides 31, 32 to connect two power tool attachment devices 12 for attaching multiple accessories. In such an implementation, each hole 33 at first side 31 and second side 32 receives a different power tool attachment device 12. Depending on the size of hole 33, either first threaded portion 20 or second threaded portion 22 inserts in respective hole 33. Subsequently, accessories 40 are connected at the threaded portion that is outside of hole 33 at both sides.

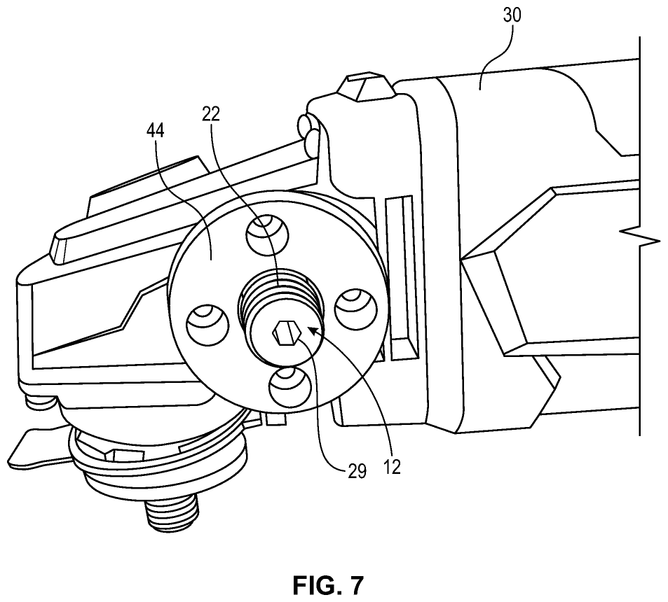

In one embodiment, first threaded portion 20 encompasses a hex wrench broach or hole 29 at first end 31, as shown in at least FIGS. 1, 2B, 4 and 6. Hex wrench broach 29 is used to connect a hex wrench (not shown) also known as an Allen wrench or Allen key to tighten power tool attachment device 12 such that second threaded portion 22 firmly secures to hole 33. Similarly, when first threaded portion 20 inserts in hole 33, second threaded portion 22 that remains outside hole 33 includes hex wrench broach 29. Hex wrench broach 29 is used to connect a hex wrench to tighten power tool attachment device 12 such that first threaded portion 20 firmly secures to hole 33. FIG. 7 shows a perspective view of second threaded portion 22 receiving nut 44 (or accessory) at first side 31 of housing 30, in accordance with another embodiment of the present invention. As can be seen, nut 44 connects at second threaded portion 22 that is outside of hole 33 while the first threaded portion 20 inserts in hole 33. In other embodiments, second threaded portion 22 includes hex wrench broach 29 that can be used to tighten power tool attachment device 12. Other types of recesses or broaches may be used that be triangular, square, or any other shape that fits a wrench having a particular complimentary shape to insert into the recess to aid in tightening without detracting from the spirit of the invention. In other words, the power tool attachment device comprises a hex wrench broach design to accept a hex wrench having a complimentary size and shape to fit within said hex wrench broach. In one embodiment the hex wrench broach 29 has hexagonal size of approximately 3/16 in. (0.1875 in.) and has a depth of approximately ¼ in. (0.25 in.) centrally positioned within the top surface of the first threaded portion 20 (or second threaded portion 22).

FIG. 7 shows a perspective view of second threaded portion 22 receiving nut 44 (or accessory) at first side 31 of housing 30, in accordance with another embodiment of the present invention. As can be seen, nut 44 connects at second threaded portion 22 that is outside of hole 33 while the first threaded portion 20 inserts in hole 33.

The embodiments provide for several advantages over the prior art. For example, the power tool attachment device helps to attach power tool accessories such as a nut directly to the power tool, so the accessories do not get lost. The power tool attachment device connects at the free hole and does not affect the operation of the power tool. The power tool attachment device has two threaded portions of varied sizes, as such the threaded portion that conforms to the shape of the hole is made to insert in the hole while the other threaded portion is made to remain outside the hole. The outer threaded portion is used to receive/attach accessories of the power tool. This way, different accessories having varied shapes and sizes can be connected to the power tool with the help of the power tool attachment device.

While the invention has been described in terms of exemplary embodiments, it is to be understood that the words that have been used are words of description and not of limitation. As is understood by persons of ordinary skill in the art, a variety of modifications can be made without departing from the scope of the invention defined by the following claims, which should be given their fullest, fair scope.

What is claimed is:

1. A power tool attachment device, comprising:
a first threaded portion; and,
a second threaded portion, wherein said second threaded portion has a shape and size different from said first threaded portion,
wherein said first threaded portion inserts in a hole of a power tool while said second threaded portion remains outside of said hole, and
wherein said accessory secures to said second threaded portion.

2. The power tool attachment device of claim 1, wherein said first threaded portion has diameter, pitch, and length, larger than said second threaded portion, and wherein at least one of the first and second portion has a nominal size and threads per inch of ⅝-11.

3. The power tool attachment device of claim 1, wherein said second threaded portion has diameter, pitch, and length, larger than said first threaded portion.

4. The power tool attachment device of claim 1, wherein said first threaded portion and said second threaded portion connect by a connecting body, wherein said connecting body has diameter different from said first threaded portion and said second threaded portion.

5. The power tool attachment device of claim 1, wherein the shape and size of said first threaded portion conforms to the shape and size of said hole of said power tool, and wherein the power tool attachment device further comprises a hex wrench broach design to accept a hex wrench having a complimentary size and shape to fit within said hex wrench broach to aid in tightening said power tool attachment device.

6. The power tool attachment device of claim 1, wherein said accessory comprises an accessory hole having a threaded portion, and wherein the shape and size of said second threaded portion conforms to the shape and size of said threaded portion of said accessory hole.

7. The power tool attachment device of claim 1, wherein said power tool comprises one of a grinder, joiner, drill, saw, screwdriver, hammer, vibrator, sander, polisher, nibbler, cutter, blower, and heat gun.

8. The power tool attachment device of claim 1, wherein said accessory comprises one of: a nut, grinding disc, drill, cutter, buffing wheel, polishing wheel, screwdriver, locking member, connecting member, vibrator, and ring.

9. A power tool, comprising:
a housing having a hole at its side;
an accessory; and,
a power tool attachment device, comprising:
a first threaded portion; and,
a second threaded portion, wherein said second threaded portion has a shape and size different from said first threaded portion,
wherein said first threaded portion inserts in said hole while said second threaded portion remains outside of said hole, and
wherein said accessory secures to said second threaded portion.

10. The power tool of claim 9, wherein said first threaded portion has diameter, pitch, and length, larger than said second threaded portion, and wherein at least one of the first and second portion has a nominal size and threads per inch of ⅝-11.

11. The power tool of claim 9, wherein said second threaded portion has diameter, pitch, and length, larger than said first threaded portion.

12. The power tool claim 9, wherein said first threaded portion and said second threaded portion connect by a connecting body, wherein said connecting body has a diameter different from said first threaded portion and said second threaded portion.

13. The power tool of claim 9, wherein the shape and size of said first threaded portion conforms to the shape and size of said hole of said power tool, and wherein the power tool attachment device further comprises a hex wrench broach design to accept a hex wrench having a complimentary size and shape to fit within said hex wrench broach to aid in tightening said power tool attachment device.

14. The power tool of claim 9, wherein said accessory comprises an accessory hole having a threaded portion, and wherein the shape and size of said second threaded portion conforms to the shape and size of said threaded portion of said accessory hole.

15. The power tool of claim 9, wherein said power tool comprises one of a grinder, joiner, drill, saw, screwdriver, hammer, vibrator, sander, polisher, nibbler, cutter, blower, and heat gun.

16. The power tool of claim 9, wherein said accessory comprises one of: a nut, grinding disc, drill, cutter, buffing wheel, polishing wheel, screwdriver, locking member, connecting member, vibrator, and ring.

17. A method of providing a power tool attachment device for securing an accessory to a power tool, the method comprising steps of:
providing a first threaded portion;
providing a second threaded portion, said second threaded portion having a shape and size different from said first threaded portion;
inserting said first threaded portion in a hole of a power tool while retaining second threaded portion outside of said hole; and
securing an accessory at said second threaded portion.

18. The method of claim 17, further comprising providing the shape and size of said first threaded portion conforming to the shape and size of said hole of said power tool.

19. The method of claim 17, further comprising providing an accessory hole having a threaded portion for said accessory.

20. The method of claim 17, further comprising providing the shape and size of said second threaded portion conforming to the shape and size of said threaded portion of said accessory hole, and wherein the power tool attachment device further comprises a hex wrench broach design to accept a hex wrench having a complimentary size and shape to fit within said hex wrench broach to aid in tightening said power tool attachment device.
